(19) United States
(12) Patent Application Publication
(10) Pub. No.: US 2026/0042673 A1
(43) Pub. Date: Feb. 12, 2026

(54) Long-term installation of downhole equipment

(71) Applicant: Saudi Arabian Oil Company, Dhahran (SA)

(72) Inventors: Hussain Abdullah Alqahtani, Dammam (SA); Abdulaziz S. Al-Qasim, Dammam (SA); Guodong Zhan, Dhahran (SA)

(21) Appl. No.: 18/796,442

(22) Filed: Aug. 7, 2024

(51) Int. Cl. E21B 23/00; C01B 32/26; E21B 47/04; E21B 47/06; F24T 10/00; F24T 10/20

(52) U.S. Cl. CPC C01B 32/26; F24T 10/20; E21B 41/00; F24T 2010/53; Y02E 10/10

(57) ABSTRACT

An approach to producing fluids from a subsurface formation includes identifying downhole locations where conditions are appropriate for a geothermal well; identifying one or more tools that will be installed at the identified downhole locations; providing the identified tool(s) covered with catalyst-free PCD coatings; and installing the tool(s) covered with PCD coatings in the identified downhole locations.

### TECHNICAL FIELD

This specification generally relates to the long-term installation of downhole equipment, particularly in high temperature, high pressure environments.

### BACKGROUND

The geothermal energy is a promising source of electricity. Geothermal reservoirs are formations that contain naturally heated water that can be accessed by wells extending from the surface. Such geothermal reservoirs are typically located between 6 to 10 kilometers (km) deep. For effective use of the Earth's heat, bottom hole temperatures are preferably at least 200 to 300° C.

Wells drilled into geothermal reservoirs can be used to tap steam and very hot water that can be brought to the surface. The associated thermal energy can be used to generate steam which is subsequently used to drive generator turbines. The wells often include equipment that is installed permanently or semi-permanently in the geothermal reservoirs.

### SUMMARY

This specification describes an approach to preparing equipment for long-term installation of equipment in high temperature, high pressure environments. This approach includes applying catalyst-free polycrystalline diamond coatings to downhole equipment. The catalyst-free polycrystalline diamond (PCD) coatings provide increased durability and excellent thermal conductivity which can protect equipment (e.g., pumps and gauges) in geothermal wells and other high-temperature, high-pressure conditions. The coatings can be applied using advanced coating processes, including chemical vapor deposition (CVD) or high-velocity air fuel (HVAF) and high-velocity oxygen fuel (HVOF) thermal spray techniques. These processes can provide secure bonding of the robust and highly thermally conductive PCD coatings to the surface of the downhole equipment.

The approach disclosed in this specification can be used to provide enhanced performance of tools installed long-term in geothermal wells and other high-temperature, high-pressure environments. The durability and thermal conductivity of the PCD coating can lead to improved operational efficiency and longevity of the tools. In particular, the natural hardness and wear resistance of PCD coatings significantly extend the lifespan of the coated tools. Additionally, the high thermal conductivity of PCD coatings improves heat transfer, thus allowing the tools to operate at higher temperatures and speeds without overheating. The enhanced durability and efficiency can reduce the need for frequent replacements and downtime, resulting in substantial financial savings.

Other advantages using PCD coatings on downhole tools include improved precision, resistance to chemical corrosion, reduced environmental impacts, enhanced safety, versatility, and energy efficiency. PCD coatings can allow for greater precision in cutting and drilling operations due to their superior hardness and wear resistance. This can lead to better quality work and fewer errors. PCD coatings are chemically inert, which means they can withstand aggressive chemical environments without degrading. This is particularly beneficial in geothermal wells where exposure to corrosive fluids can be an issue. By extending the life of tools and reducing the need for replacements, PCD coatings contribute to lower waste generation and a reduced environmental footprint. The reliability of PCD-coated tools can also improve safety by reducing the risk of tool failure, which can be critical in high-risk environments. PCD coatings can be applied to a variety of substrates and used in different types of drilling and mining equipment, making them versatile for various applications. The high thermal conductivity of PCD allows for efficient heat dissipation, which can lead to energy savings during the operation of the tools.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

FIG. 1A is a schematic view illustrating a geothermal power generation system. FIG. 1B is a larger-scale schematic view of a portion of the geothermal power generation system that including an electric submersible pump and a pressure gauge.

FIG. 2 is a perspective view of an electric submersible pump.

FIG. 3 is a perspective view of a pressure gauge.

FIG. 4 is a flow chart illustrating a method of preparing equipment for long term installation downhole.

FIG. 5 is a schematic view of a high velocity oxygen fuel system being used to apply a catalyst free-diamond coating to an electric submersible pump.

FIG. 6 is a schematic view of a chemical vapor deposition system being used to apply a catalyst free-diamond coating to a pressure gauge.

Like reference symbols in the various drawings indicate like elements.

### DETAILED DESCRIPTION

This specification describes an approach to preparing equipment for long-term installation of equipment in high temperature, high pressure environments. This approach includes applying catalyst-free polycrystalline diamond coatings to downhole equipment. The catalyst-free polycrystalline diamond (PCD) coatings provide increased durability and excellent thermal conductivity which can protect equipment (e.g., pumps and gauges) in geothermal wells and other high-temperature, high-pressure conditions. The coatings can be applied using advanced coating processes, including chemical vapor deposition (CVD) or high-velocity air fuel (HVAF) and high-velocity oxygen fuel (HVOF) thermal spray techniques. These processes can provide secure bonding of the robust and highly thermally conductive PCD coatings to the surface of the downhole equipment.

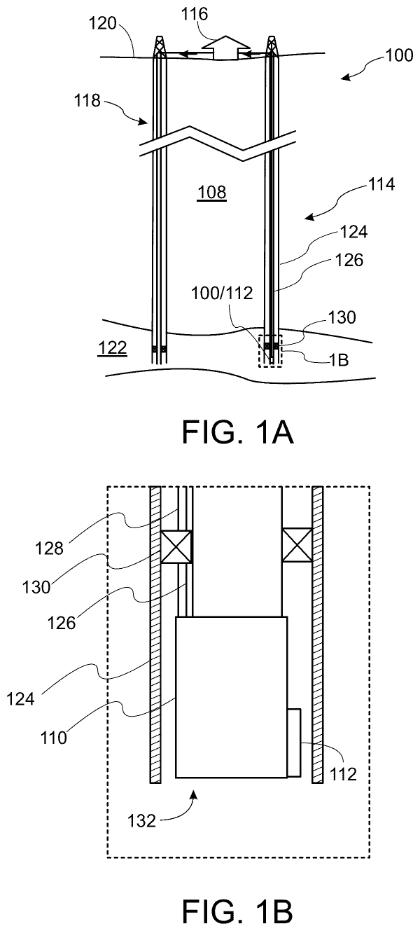

FIG. 1A is a schematic view illustrating a geothermal power generation system 100. FIG. 1B is a larger-scale schematic view of a portion of the geothermal power generation system 100 that including an electric submersible pump 110 and a pressure gauge 112. The electric submersible pump (ESP) 110 and the pressure gauge 112 are covered with a PDC coating.

The geothermal power system 100 includes an extraction well 114, a power plant 116, and an injection well 118. The extraction well 114 and the injection well 116 extend from surface 120 to a geothermal reservoir 122 deep in the earth. The wellbores of the extraction well 114 and the injection well 116 is substantially vertical; however, some wellbores include both vertical and other-than-vertical (such as substantially horizontal) portions, and can comprise a single wellbore or can include multiple lateral wellbores. The extraction well 114 and the injection well 116 each also includes a wellhead which can include various spools, valves and adapters to provide pressure and flow control from wells.

The extraction well includes a casing 124 installed and cemented in place within wellbore to stabilize the wellbore. The ESP 120 is positioned at a downhole end of production tubing string 126. As illustrated, the ESP 110 has a single centrifugal pump sections powered from surface electrical system via control and power line 128. The ESP 110 is operable to draw fluids from the geothermal reservoir 122 in an uphole direction through a central bore of production tubing string 126. In the illustrated embodiment, a packer 130 seals the tubing-casing annulus (TCA) 162 formed by the interior surface of casing 124 and the exterior surface of production tubing string 126, uphole of the ESP 110. Packer 160 can be configured to isolate the TCA volume downhole of packer 130 from the TCA volume uphole of packer 130.

The extraction well 114 and the injection well 116 can both include a plurality of downhole sensors to monitor various downhole parameters including but not limited to pressure, temperature, and vibration of the ESP 110 and of its components and other downhole components of the wells. These sensors include the pressure gauge 112 (shown in FIG. 1B) which is positioned near an intake 132 of the ESP 110 and configured to measure the pressure of fluids entering the ESP 110 during ESP operation.

Operation of the ESP 110 pumps fluids from the geothermal reservoir 122 to the surface where the fluids are transferred to the power plant 116. The power plant 116 is a flash steam plant. Fluids from the geothermal reservoir 122 at temperatures greater than 182° C./360° F. are pumped from deep underground to a low-pressure tank at the surface. The change in pressure causes some of the fluid to flash into steam which is used drive generator turbines. The ESP 110 and the pressure gauge 112 can also be used with other types of geothermal plants (e.g., dry steam plants and binary cycle plants).

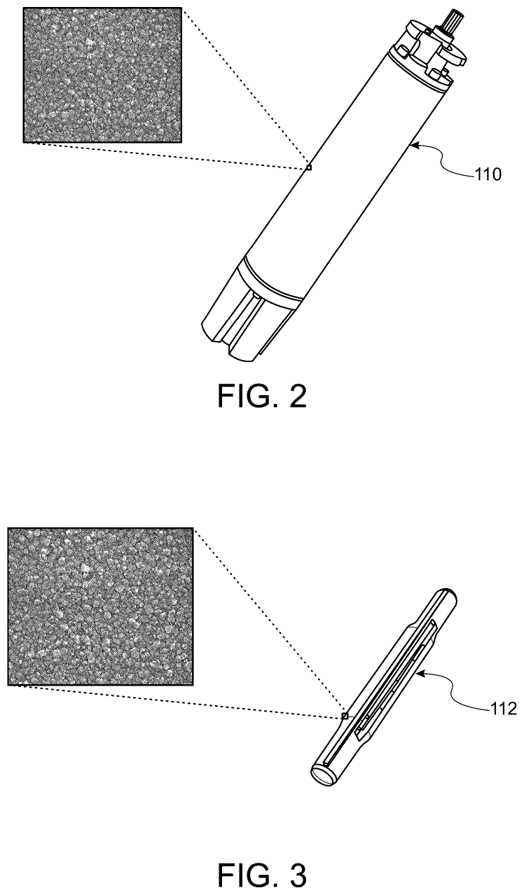

FIG. 2 is a perspective view of an exemplary ESP 110 covered with a PCD coating. The ESP 110 is a robust and efficient device used to lift fluids from deep underground to the surface. The ESP 110 includes a series of centrifugal pump stages, each containing a rotating impeller and a stationary diffuser, which work together to increase the pressure of the fluid. These pumps are designed to withstand the harsh conditions of geothermal reservoirs, including high temperatures and pressures.

FIG. 3 is a perspective view of a pressure gauge 112 (e.g., a pressure gauge used to measure the pressure of the fluid within the geothermal well) covered with a PCD coating. It is crucial for monitoring the operational status and ensuring the safety of the geothermal plant. A typical pressure gauge for such applications would be constructed from materials capable of withstanding extreme temperatures and corrosive fluids.

Referring to both FIG. 2 and FIG. 3, both the ESP 110 and the pressure gauge 112 are covered with PCD coatings that are resistant to the harsh conditions encountered in reservoirs. The high thermal conductivity of PCD allows the tools to operate at higher speeds without overheating, while its hardness and wear resistance extend the tool's lifespan. This results in cost savings due to reduced need for tool replacement and downtime.

Although this approach can be applied to other tools, the benefits of this technology are particularly noticeable with tools like ESPs or permanent downhole pressure gauges. For instance, ESPs often suffer from corrosion due to the harsh downhole environment characterized by high temperature, pressure, and the presence of corrosive fluids like H₂S. This prolonged exposure can reduce the equipment lifespan and impair its performance. The catalyst-free PCD coating is typically applied to all portions of the tools that interact with fluids downhole. For example, the coating process on ESP tools should be thorough, covering both the fluid inlet and the exterior of the ESP. In some implementations, coating the interior portions of ESP tools that come into contact with formation water can be achieved using techniques such as chemical vapor deposition.

Covering downhole tools with PCD coatings can increase the initial capital costs associated with the tools. However, the cost per unit of production can be significantly lower with PCD coated tools due to their longer lifespan and durability. In the right application, the investment in PCD tools pays off quickly, especially when considering the reduced downtime and maintenance costs. However, the decision to coat most tools or limit the use to specific conditions should be based on a detailed cost-benefit analysis, taking into account the specific operational environment and the expected increase in tool life.

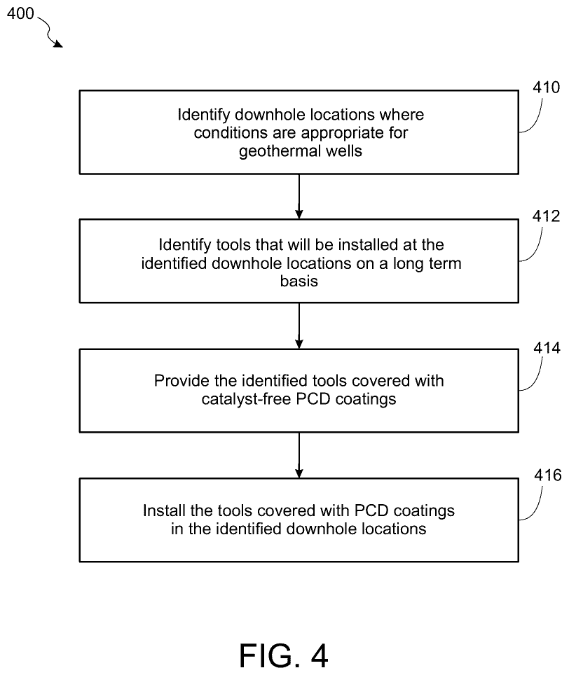

FIG. 4 is a flow chart illustrating a method 400 for long-term installation of equipment downhole. Downhole locations are identified where high pressure, high temperature conditions are present (step 410). As previously discussed, such conditions are often present in geothermal reservoirs. They are also sometimes present in drilling wells in abrasive formations where standard tools wear out quickly and mining operations where drilling and cutting tools are subject to extreme wear and tear.

In some implementations, the downhole locations are identified based on data regarding actual downhole conditions (e.g., well logging data which provides detailed records of the geological formation and drilling process data which can indicate changes in conditions based on drilling performance). Historical data and expert rules can also be used to establish a knowledge base for downhole condition identification. In some implementations, the downhole locations are identified based on screening parameters rather than data about actual downhole conditions. For example, conditions at the bottom of a geothermal well extending more than a kilometer below the surface may be assumed to warrant identifying the well bottom as an appropriate downhole location. The default depth for geothermal wells to warrant the use of PCD tools can vary, but it is generally assumed that deeper wells with higher temperatures and pressures would benefit from PCD coatings. For instance, geothermal gradients can range from 5° to 70° per kilometre, and in high-enthalpy geothermal systems, temperatures can be significant enough to justify PCD use at depths of several kilometers. It's important to consider local geothermal conditions and historical data to determine the appropriate depth for PCD tool implementation.

Tools that will be installed at the identified downhole locations on a long-term basis are then identified (step 412). In the context of downhole tools, “long-term” typically refers to installations that are expected to last for several years. The exact duration can vary based on the specific conditions of the well and the operational requirements, but it generally ranges from 1 to 5 years or more. For the purposes of this approach, tools that will remain downhole for more than a month (e.g., more than six months, more than a year) are considered to be tools that will be installed at the identified downhole locations on a long-term basis. For example, ESPS and pressure gauges that are installed and remain downhole are installed on a long-term basis. In contrast, a wireline logging which is lowered into and retrieved from a wellbore is not installed on a long-term basis. The identification can also be based on the extent to which the tools are made of metal that is exposed to formation fluids. For example, ESPs and pressure gauges have outer metal surfaces that are exposed to formation fluids. In contrast, tools that do not have direct contact with formation fluids or are not exposed to abrasive actions may not need such coatings.

When deciding whether to apply PCD coating, factors to consider include material compatibility, operational environment, and cost-benefit analysis. Tto prevent delamination, this approach should only be used on tools in which the base material of the tool is compatible with the PCD coating. The temperature, pressure, and chemical exposure of a tool's operational environment should be assessed to determine whether a PCD coating is necessary. The cost of applying the coating should be compared to the potential savings from extended tool life and reduced downtime.

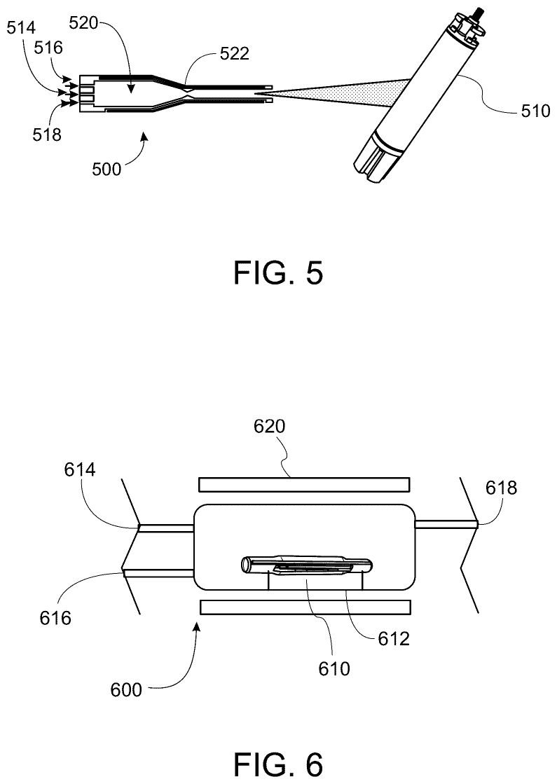

After the tools that will be installed at the identified downhole locations on a long-term basis are identified, the identified tools are provided covered with catalyst-free PCD coatings (step 414). In some cases, the identified tools can be covered with catalyst-free PCD coatings using thermal spray techniques (e.g., as described with reference to FIG. 5), using chemical vapor deposition techniques (e.g., as described with reference to FIG. 6), or other techniques. The coated tool is then rigorous tested to verify the quality of the coating with this testing including checking the coating's thickness, hardness, and thermal conductivity. For example, micrometers or other precise measuring tools can be used to check that the coating is within the specified range, usually between 5 to 100 microns. Vickers hardness testing can be employed to measure the coating's resistance to indentation. The acceptable range for PCD coatings is typically around 6000 to 8500 Vickers.

The tools covered with PCD coatings are then installed in the identified downhole locations (step 416). The coated tools have generally the same shape and dimensions as they did before being coated and standard installation techniques can be used. For example, the installation of an ESP in a geothermal well typically involves lowering the pump into the wellbore to the desired depth, typically using a tubing string. The ESP is then connected to the power source and control systems at the surface. It's crucial to ensure that the ESP is rated for the high temperatures and pressures encountered in geothermal wells, and that the materials used in the ESP, including any coatings, are suitable for the geothermal fluid characteristics.

FIG. 5 is a schematic view of a high velocity oxygen fuel system 500 being used to apply a catalyst free-diamond coating to an electric submersible pump 510. The high velocity oxygen fuel system 500 has body 512 with three inlets: a powder inlet 514, an oxygen inlet 516, and a fuel inlet 518 which feed into a combustion chamber 520. The combustion chamber 520 has an outlet through a nozzle 522. A carrier gas (e.g., nitrogen gas) with a catalyst-free diamond powder injected into the combustion chamber 520 through the powder inlet 514 at the same time as fuel (e.g., hydrogen, propane, or kerosene) and oxygen are injected into combustion chamber through the oxygen inlet 516 and the fuel inlet 518. Although illustrated schematically with the oxygen inlet 516 and the fuel inlet 518 bracketing the powder inlet, there are many configurations for bodies of high velocity oxygen fuel systems. For example, some high velocity oxygen fuel systems have bodies defining a central powder inlet surrounded by annular fuel and oxygen inlets and, in some cases, an outer annular compressed air inlet. Although illustrated as applying a coating to exterior surfaces of the ESP 510, this approach can also be used to apply coatings to the inner surfaces.

In operation, fuel and oxygen are fed into the combustion chamber 520 and ignited. The resultant gas, with an extremely high temperature and pressure, is ejected through a nozzle at supersonic speeds (e.g., 2000 m/s or more). The operating temperature and pressure depend on the specific HVOF system and operating conditions. Combustion is typically ignite by a spark with initial combustion heating an insert which then provides ongoing ignition of the gases.

The catalyst-free diamond powder injected into the high-velocity gas stream, which heats the powder and directs it towards the surface to be coated. The molten or semi-molten powder contacts and bonds to the surface. The high impact speed of the particles produces a highly adherent, dense coating structure with low porosity and high bond strength. Following the deposition of the catalyst-free PCD layer, the coated tool undergoes a high-temperature curing process that solidifies the coating and enhances bonding between the PCD layer and the tool's surface.

HVAF systems are generally similar to HVOF systems. However, HVAF systems combine fuel with heated compressed air rather than oxygen. HVAF combustion temperatures are usually significantly lower than HVOF combustion temperatures.

FIG. 6 is a schematic view of a chemical vapor deposition system 600 being used to apply a catalyst free-diamond coating to a pressure gauge 610. The chemical vapor deposition system 600 has a reactor 612 sized to receive the tool or tool components which are being coated with a catalyst-free diamond coating. The reactor 612 has two gas inlets 614, 616 and a gas outlet 618 and is heated by an external furnace 620 extending around the chamber.

In operation, the tool surface is conditioned before the coating is applied. Surface conditioning involves preparing the tool's surface to enhance adhesion of the subsequent coating. Surface conditioning can include cleaning, roughening, and activating the surface to enhance coating adhesion.

The tool is then placed in the reactor 612, where it is exposed to a mixture of gases at high temperatures. The gas mixture typically includes a carbon source (e.g., methane) and hydrogen which are fed into the reactor 612 through the two gas inlets 614, 616. Energy supplied by the furnace generates a plasma in which the gases are broken down and more complex chemistries occur. Some systems use other energy sources including, for example, hot filament, microwave power, and arc discharges.

The gases break down and the carbon atoms recombine on the surface of the tool, forming a thin layer of diamond. The carbon atoms continue to deposit onto the tool's surface, gradually forming a layer of PCD with the thickness of the coating controlled by adjusting the duration of the CVD process. The excess gases exit the reactor 612 through a gas outlet 618.

### Examples

In some implementations, methods for producing fluids from a geothermal reservoir include: identifying downhole locations where conditions are appropriate for a geothermal well; identifying one or more tools that will be installed at the identified downhole locations; providing the identified tool(s) covered with catalyst-free PCD coatings; and installing the tool(s) covered with PCD coatings in the identified downhole locations.

In some implementations, methods for producing fluids from a subsurface formation include: identifying downhole locations where temperatures exceeding 150° C. (302° F.) and pressures exceed 69 MPa (10,000 psi); identifying one or more tools that will be installed at the identified downhole locations; providing the identified tool(s) covered with catalyst-free PCD coatings; and installing the tool(s) covered with PCD coatings in the identified downhole locations.

In an example implementation combinable with any other example implementation, the downhole locations are identified based at least in part on data regarding actual downhole conditions. In some cases, the downhole locations are identified based at least in part on well logging data.

In an example implementation combinable with any other example implementation, the downhole locations are identified based at least in part on screening parameters. In some cases, the screening parameters include well depth.

In an example implementation combinable with any other example implementation, identifying the tool(s) comprises identifying one or more tools that will remain downhole for more than a year. In some cases, the identified tools are electric submersible pumps, permanent downhole pressure gauges, or both.

In an example implementation combinable with any other example implementation, providing the identified tool(s) covered with catalyst-free polycrystalline diamond (PCD) coatings comprises applying catalyst-free PCD coatings using thermal spray techniques.

In an example implementation combinable with any other example implementation, providing the identified tool(s) covered with catalyst-free polycrystalline diamond (PCD) coatings comprises applying catalyst-free PCD coatings using chemical vapor deposition techniques.

In an example implementation combinable with any other example implementation, methods also include testing thickness, hardness, and thermal conductivity of the PCD coatings.

A number of embodiments of the systems and methods have been described. Nevertheless, it will be understood that various modifications may be made without departing from the spirit and scope of this specification. Accordingly, other embodiments are within the scope of the following claims.

What is claimed is:

1. A method for producing fluids from a geothermal reservoir, the method comprising:
identifying downhole locations where conditions are appropriate for a geothermal well;
identifying one or more tools that will be installed at the identified downhole locations;
providing the identified tool(s) covered with catalyst-free PCD coatings; and
installing the tool(s) covered with PCD coatings in the identified downhole locations.

2. The method of claim 1, wherein the downhole locations are identified based at least in part on data regarding actual downhole conditions.

3. The method of claim 2, wherein the downhole locations are identified based at least in part on well logging data.

4. The method of claim 1, wherein the downhole locations are identified based at least in part on screening parameters.

5. The method of claim 4, wherein the screening parameters include well depth.

6. The method of claim 1, wherein identifying the tool(s) comprises identifying one or more tools that will remain downhole for more than a year.

7. The method of claim 6, wherein the identified tools are electric submersible pumps, permanent downhole pressure gauges, or both.

8. The method of claim 1, wherein providing the identified tool(s) covered with catalyst-free polycrystalline diamond (PCD) coatings comprises applying catalyst-free PCD coatings using thermal spray techniques.

9. The method of claim 1, wherein providing the identified tool(s) covered with catalyst-free polycrystalline diamond (PCD) coatings comprises applying catalyst-free PCD coatings using chemical vapor deposition techniques.

10. The method of claim 1, further comprising testing thickness, hardness, and thermal conductivity of the PCD coatings.

11. A method for producing fluids from a subsurface formation, the method comprising:
identifying downhole locations where temperatures exceeding 150° C. (302° F.) and pressures exceed 69 MPa (10,000 psi)
identifying one or more tools that will be installed at the identified downhole locations;
providing the identified tool(s) covered with catalyst-free PCD coatings; and
installing the tool(s) covered with PCD coatings in the identified downhole locations.

12. The method of claim 11, wherein the downhole locations are identified based at least in part on data regarding actual downhole conditions.

13. The method of claim 12, wherein the downhole locations are identified based at least in part on well logging data.

14. The method of claim 11, wherein the downhole locations are identified based at least in part on screening parameters.

15. The method of claim 14, wherein the screening parameters include well depth.

16. The method of claim 11, wherein identifying the tool(s) comprises identifying one or more tools that will remain downhole for more than a year.

17. The method of claim 16, wherein the identified tools are electric submersible pumps, permanent downhole pressure gauges, or both.

18. The method of claim 11, wherein providing the identified tool(s) covered with catalyst-free polycrystalline diamond (PCD) coatings comprises applying catalyst-free PCD coatings using thermal spray techniques.

19. The method of claim 11, wherein providing the identified tool(s) covered with catalyst-free polycrystalline diamond (PCD) coatings comprises applying catalyst-free PCD coatings using chemical vapor deposition techniques.

20. The method of claim 11, further comprising testing thickness, hardness, and thermal conductivity of the PCD coatings.
